(19) United States
(12) Patent Application Publication
(10) Pub. No.: US 2021/0223781 A1
(43) Pub. Date: Jul. 22, 2021

(54) Systems and Methods for Controlling Mobility Devices

(71) Applicant: Invacare Corportion, Elyria, OH (US)

(72) Inventors: Lisa M. Rotelli, Lakeway, TX (US); Gary E. Chopcinski, North Ridgeville, OH (US); Toan Pham, Cedar Park, TX (US); Stanley Cozby, Marble Falls, TX (US); Trevor J. Parsh, North Ridgeville, OH (US); Joe Anthony Cervantez, Granite Shoals, TX (US)

(21) Appl. No.: 17/153,009

(22) Filed: Jan. 20, 2021

Related U.S. Application Data
(60) Provisional application No. 62/964,641, filed on Jan. 22, 2020.
(60) Provisional application No. 62/994,012, filed on Mar. 24, 2020.

(51) Int. Cl. G05D 1/02; A61G 5/10

(52) U.S. Cl. CPC G05D 1/0223; A61G 5/041; A61G 5/10

(57) ABSTRACT

Embodiments of a mobility vehicle control system are provided. In one embodiment, a head array and control system are provided that allow for adjustment of a plurality of parameters associated with the head array including, for example, sensor pad settings, user settings, and feature settings. A veer adjust interface is also provided as a performance setting adjustment to allow for correction of any veer by the vehicle when being driven.

### CROSS-REFERENCES TO RELATED APPLICATIONS

This application claims priority is to U.S. Provisional patent application Ser. Nos. 62/964,641 filed Jan. 22, 2020 and 62/994,012 filed Mar. 24, 2020, which are fully incorporated herein by reference.

### BACKGROUND

Mobility vehicles such as, for example, wheelchairs and the like, are an important means of transportation for a significant segment of society. Persons requiring the use of a wheelchair often vary in their ability to maneuver and control wheelchair. In situations where the user is unable to propel the wheelchair manually, a motorized or power wheelchair is often required. Power wheelchairs require controls and systems to interpret the operator's desired direction and speed.

Existing power wheelchair control systems predominately employ joystick controls. Joystick controls are not well suited for persons with limited or no dexterity in the hands. Therefore, alternative control configurations such as switch control may be utilized to replace traditional joystick controls. Other alternative control configurations including, for example, fiber-optic switches, proximity switch head arrays, and sip'n'puff controls have also been used to replace traditional joystick controls.

Head arrays, for example, allow a user to use movement of their head with respect to sensors and/or switches to control the movement of a power wheelchair. While head arrays remain an important input control system for power wheelchair users, a need exists for improvements.

### SUMMARY

In one embodiment, a control system for a power wheelchair is provided having a head array with both proportional and digital input capability. The proportional capability includes the ability to physically sense a range of forces or pressures being applied by the user to a control pad of the head array. This proportional input provides a proportional speed and/or direction signal for driving the power wheelchair. The digital capability includes the ability to provide an active or not active input being applied by the user to a control pad. The active input is provided when the user is touching the control pad or within proximity (operation range or distance) of a control pad. The not active input is provided when the user is not touching the control pad or not within the proximity (operating range or distance). The sensors can be force or capacitive sensing, or both. In this manner, the control system can be tailored to the strength or weakness of a user's ability to use their head as a control input.

In another embodiment, a control system is provided having a head array with a programmer. The programmer can include a display and one or more inputs for programming the head array and allowing the head array to control various functions of the power wheelchair control system.

In another embodiment, a control system is provided having a head array capable of controlling external devices such as computers, mice, game controllers, telephones, televisions, and other devices associated with the user's environment. The control can be via a wireless link with the head array sensor pads providing input to the external devices.

In another embodiment, a control system is provided having a head array with a veer adjust and compensation capability to assist the power wheelchair to travel in a straight line (versus veering to the left or right).

In another embodiment, a control system is provided having a head array with multiple sensors in one or more control pads. Each pad can include, for example, two sensors in the form of a proximity sensor and a force (or pressure) sensor. Each of the multiple sensors can be used to provide distinct drive inputs and commands.

In another embodiment, a control system is provided having the ability to assign multiple functions based on a single button or switch press or sequence.

### BRIEF DESCRIPTION OF THE DRAWINGS

In the accompanying drawings which are incorporated in and constitute a part of the specification, embodiments of the invention are illustrated, which, together with a general description of the inventions above, and the detailed descriptions given below, serve to example the principles of the inventions.

FIG. 1 illustrates one embodiment of a power wheelchair having a control system that includes a head array.

FIGS. 2 and 3 illustrate one embodiment of a head array system.

FIG. 4 is a partial cross-sectional view of one embodiment of a control or sensor pad.

FIG. 5 illustrates one embodiment of a control system block diagram.

FIG. 6 illustrates one embodiment of a veer adjust system block diagram.

FIG. 7 illustrates one embodiment of a control system using multiple sensors of the head array as input controls for driving a wheelchair.

FIG. 8 illustrates one embodiment of logic, function and programming components.

FIG. 9 illustrates one embodiment of a programmer and display device.

FIGS. 10 and 11 illustrate one embodiment of a control interface device.

FIG. 11 illustrates one embodiment of an interface control system.

FIGS. 12-42 illustrate various embodiments of logic, functions and programming components including programmer touch screen displays and functions and programming sequences.

FIGS. 43 and 44 illustrate embodiments of high-level logic and flow diagrams of programmer touch screen displays, functions, and programming sequences.

FIG. 45 illustrates one embodiment of logic for use when a Seating Function is selected.

### DESCRIPTION

Embodiments of the invention provide, for example, the ability to tailor a head array control system based on the strength/weakness of a user. For users with a relatively high degree of head dexterity and control, the head array control system can be configured to provide a proportional input similar to a joystick type input to drive a power wheelchair. For users with less dexterity and control, the head array control system can be configured to provide a digital input similar to a switch type input (on/off) to drive a power wheelchair.

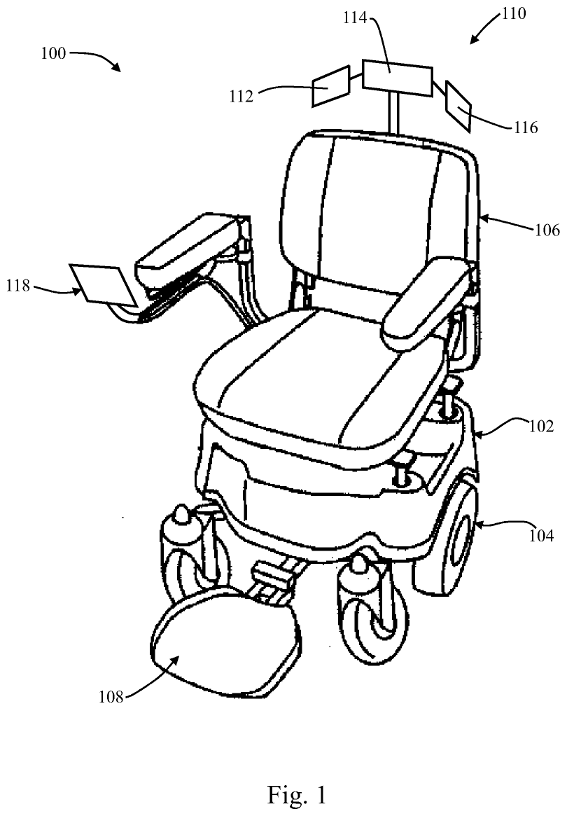

FIG. 1 illustrates one embodiment of a power wheelchair 100. Power wheelchair 100 can be of various configurations such as a rear wheel drive, center wheel drive, or front-wheel-drive wheelchair. Power wheelchair 100 includes a base 102 and left and right motor driven wheels 104. The seating system 106 is also connected to the base and may be powered for tilt, recline, and/or raise, if necessary. A front rigging 108 such as a footplate or other foot/leg rest arrangement can be provided. Power wheelchair 100 is shown as also including a head array 110 that includes left, right, and back control/sensor pads 116, 112, and 114, respectively. As will be described in more detail, the control pads can include one or more sensors for determining the position of a user's head and to provide drive inputs based thereon. Power wheelchair 100 is also shown as having an optional programmer and display 118.

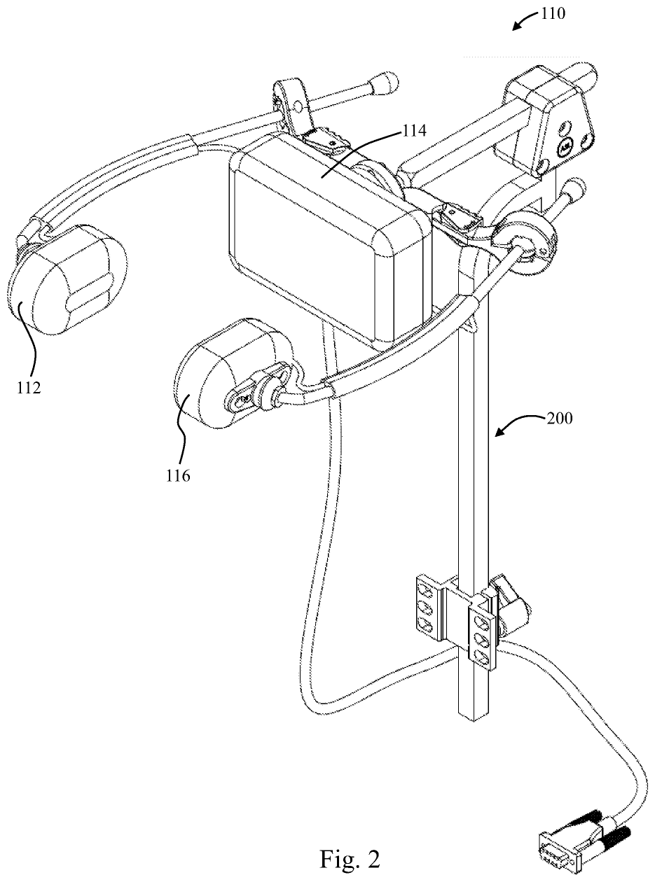

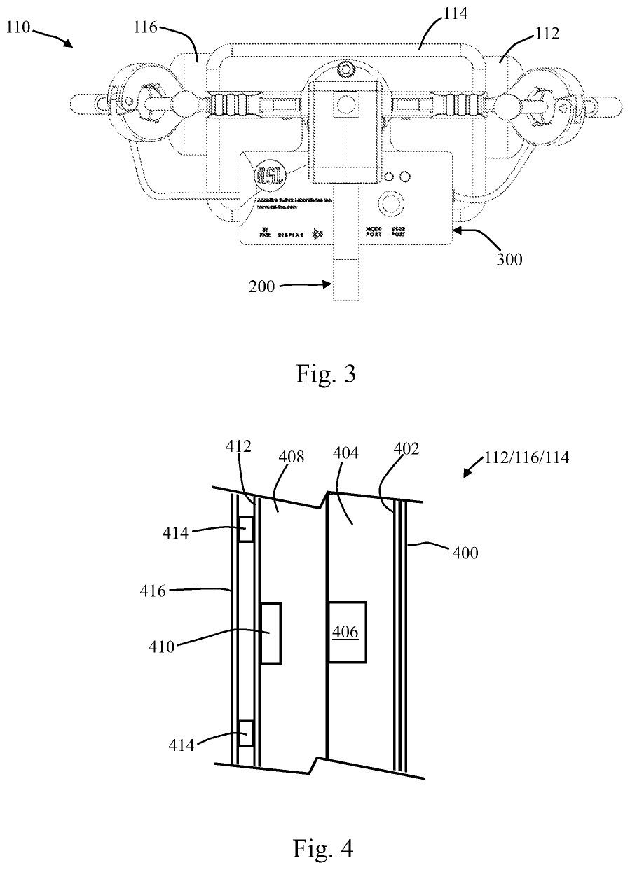

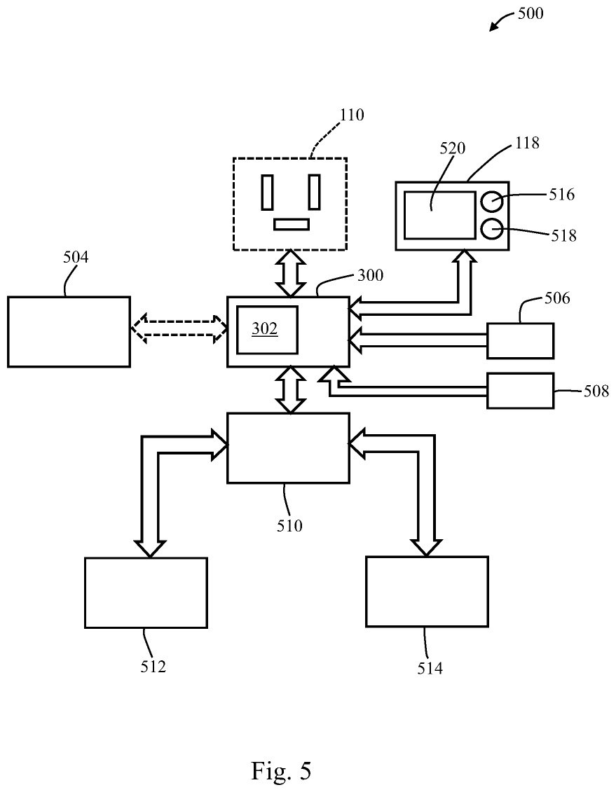

FIGS. 2 and 3 illustrate one embodiment of a head array arrangement 110 including control pads 112, 114, and 116. The head array arrangement 110 is connected to a mounting system 200 for mounting the head array arrangement 110 to the seat back of the power wheelchair. FIG. 3 also illustrates one embodiment of an interface control 300, which is further discussed in connection with FIG. 5.

FIG. 4 illustrates one embodiment of a control or sensor pad construction (e.g., 112, 114, and/or 116). The construction includes an outer durable layer 400 such as, for example, vinyl or other suitable material for contacting a user's head. A hook and loop (or other type of attachment) layer 402 connects the outer durable layer 400 to a first resilient foam layer 404. Foam layer 404 can include a proximity sensor 406 located within a cavity, compartment or section. Alternatively, proximity sensor 406 can be located against the outer surface of foam layer 404 (instead of within a cavity, compartment or section thereof). The proximity sensor 406 may be in the form of a capacitive proximity sensor or other suitable proximity sensor. A second resilient foam layer 408 is provided. A second sensor in the form of a force or pressure sensor 410 is provided on a circuit board 412, against which second foam layer 408 is in contact (and may be affixed). Sensors 406 and 410 can be positioned offset from each other so they do not overlap when viewed in a plan view. Optional spacers 414 can be provided to mount the entire assembly to a metal or support bracket 416.

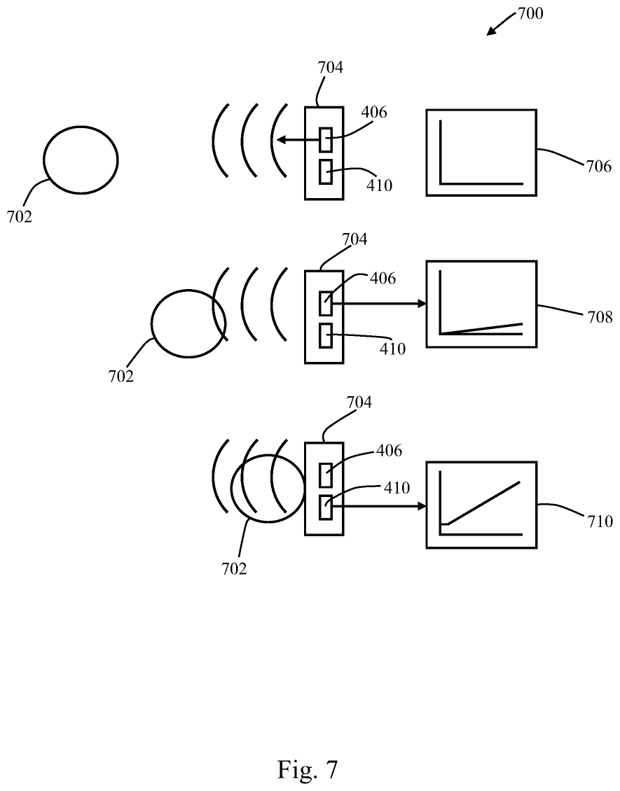

In operation, proximity sensor 406 is able to sense the presence of the user's head prior to the user making contact with the control pad. When the user's head makes contact with the control pad, force or pressure sensor 410 senses the amount of force or pressure that is being applied by the user. The force of the user's contact is translated across the outer layer 400, Velcro layer 402 (if any), and first and second foam layers to the force or pressure sensor 410 mounted on circuit board 412. In this manner, the control system can use the output of the proximity sensor 406 and the output of the force or pressure sensor 410 to appropriately drive or control the wheelchair (or other connected devices), which will be discussed further in connection with FIG. 7.

FIG. 5 illustrates one embodiment of a control system 500. Control system 100 includes hear array 110, programmer and display 118, and control interface 300. These components can be provided as stand-alone or further in combination with a main controller 510 for controlling the motor systems 512 and 514 for driving the wheels. Main controller 510 is preferably a micro-processor-based controller having memory and/or storage for data and computer instructions. Main controller 510 can have its own display and input devices (e.g., button(s), joystick, etc.) Main controller 510 can be programmed with a plurality of profiles having defined wheelchair functions (e.g., drive, seating, connectivity, etc.) One example of a main controller includes the LiNX REM400 control system manufactured by Dynamic Controls of Christchurch, New Zealand. Another example includes the MK6i electronics manufactured by Invacare Corp. of Elyria, Ohio. Yet another example includes the R-Net wheelchair control system by Curtiss-Wright Corp. Industrial Division—Penny and Giles of Christchurch, UK.

In operation, head array 110 provides drive input signals to control interface 300. Control interface 300 is preferably a micro-processor-based device having memory and/or storage for data and computer instructions. Control interface 300 can have its own display and input/output devices and ports (e.g., button(s), joystick, etc.) Control interface 300 translates the head array 110 signals to, in one embodiment, speed and directions signals for input to main controller 510 for driving the motors. In another embodiment, head array 110 can provide input signals to control interface 300 to control external devices 504 by wired or wireless communication. These external devices can include Bluetooth controllable devices such as computers, mice, game controllers, telephones, tablets, televisions, smart phones, and other devices in the user's environment.

Control interface 300 also include one or more input ports for external input switches 506 and 508 to be connected. A first port can be a mode port for providing mode selection input signal(s) to main controller 510. A second port can be a user port for providing switch input (such as for, example, an external on/off switch) for the control interface 300 (and main controller 510). Control switches 506 and 508 can each be single switches or multiple switch units. In the case of single switches, control interface 300 can assign multiple functions to each single switch based on the switch depression timing, duration and/or sequence. This reduces the hardware requirement necessary to achieve multi-functional inputs. Control interface 300 includes logic 302, which will be described in more detail, for programming and controlling the functions of the head array control system.

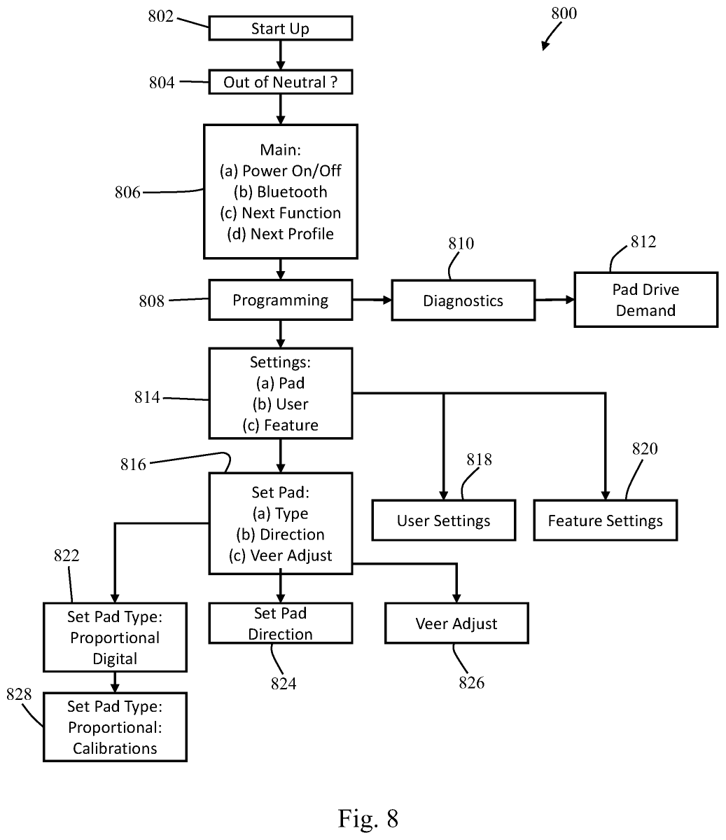

Programmer and display 118 provides programming and other functions such as display, input, selection, diagnostics and navigation. Programmer 118 is preferably a micro-processor-based device having memory and/or storage for data and computer instructions. Programmer 118 can have its own display and input devices (e.g., button(s), switches, joystick, etc.) Programmer 118 includes a touch display 520 and a plurality of input switches or buttons 516 and 518. Programmer 118 can in the form a handheld device, smartphone application, tablet application, PC or MAC program application. Programmer 118 may communicate with other system components via wired or wireless communication (e.g., Wi-Fi, Bluetooth, or other radio frequency protocol.) As will be described in connection with FIGS. 8-43, programmer 118 allows the head array control system to be tailored to the specific characteristics of each user in order to provide a greater degree of customization and capacities for each user in driving and controlling the power wheelchair (or other connected devices, e.g., 504). This tailoring can be accomplished by customizing settings and parameters of the pads of the head array and how the head array control signals drive a power wheelchair.

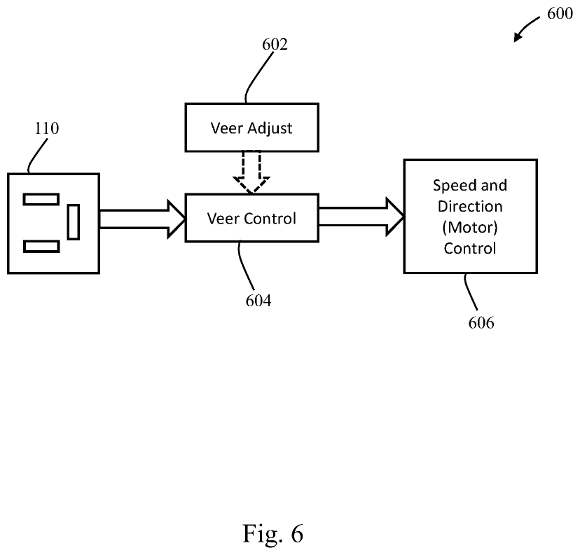

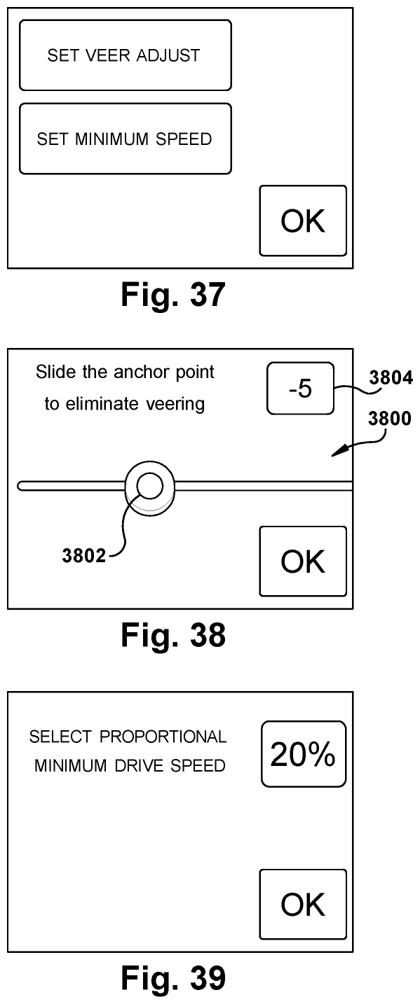

FIG. 6 illustrates one embodiment of a veer control system 600 provided by control system 500. Due to manufacturing variances, many power wheelchairs do not drive in a straight line when given a simple forward command, but instead exhibit veer (e.g., tending to drive more to the left or right instead of straight ahead). Control system 500 provides a veer adjust 602 and control 604 to correct for any veer the wheelchair may be exhibiting when a forward (or other) drive command is given by the head array 110. As shown in FIGS. 37-38, a veer adjust setting is displayed and selectable to reduce or eliminate veering. When the veer adjust setting is selected, a slider bar is displayed that can be adjusted left or right from the center position to provide a veer correction signal that is added to the direction (and/or speed) signal generated from the head array 110. The adjusted input signal is then used to drive the left and right motors of the wheelchair to correct for veer, so the wheelchair drives straight ahead.

FIG. 7 illustrates one embodiment of a control system 700 using multiple sensors from the head array 110 to drive the wheelchair. One or more control pads 704 (which can be pads 112, 114 and/or 116) monitor the proximity and location of a user's head 702. In this embodiment, each control pad includes a proximity sensor 406 and a force sensor 410. When the user's head 702 is distant from the control pad 704, no drive input is provided, and the speed of the wheelchair is essentially zero as shown in 706. As the user's head 702 moves closer to the control pad 704, proximity sensor 406 detects the user's head and a first drive input signal is provided, which results in the wheelchair being driven a small amount (or at a slow speed) as shown in speed diagram 708. That small amount can include a limited speed range or a gradual step up to a limited speed level. When the user's head 702 makes contact with the control pad 704, force sensor 410 detects the amount of force being applied by the user and increases the speed of the wheelchair as shown in the speed diagram of 710. This increase can be from the previous described limited speed range or level or from any speed there within. Speed diagrams 706, 708 and 710 illustrate just one embodiment of how two sensors can be used to proportionally control the speed of the wheelchair. Other speed controls including latched and stepped latched are also possible by this arrangement.

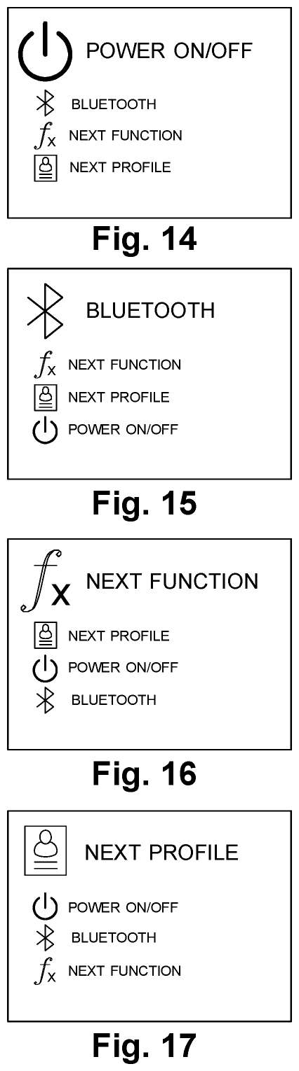

FIG. 8 illustrates one embodiment of the logic, function and programming components of the control system 500. A start-up check function and screen 802 (e.g., FIG. 13) are provided. An “out of neutral” check 804 and display (e.g., FIG. 14) is provided as a safety function. The “out of neutral” display is generated if any of the pads are activated (via either proximity or force) while the system is powering up. If this condition exists, the display will instruct the user to move away from the activated pad(s) to clear the “out of neutral” state.

A main function 806 and display (e.g., FIG. 14) is provided as the main control loop of the system and logic. While Bluetooth, Next Function, and Next Profile are shown, these are exemplary and other system functions can also be displayed and selected. If the switch (e.g., 506 or 508) is pressed and held for a short duration, the next line item (e.g., Bluetooth as shown in FIG. 15) will be highlighted. If the switch is pressed again and held for a short duration, the next line item (e.g., Next Function as shown in FIG. 16) will be highlighted. The next press and hold will advance the display to next item (e.g., Next Profile as shown in FIG. 17). If the switch is momentarily pressed and released, then the highlighted line item is selected, and a control selection signal based thereon is sent to main controller 510 to indicate this is the selected function for control by user input device(s). Audio cues can also be provided to facilitate this type of navigation including, for example, a fast-double beep when changing between line items. Other tones or sounds can also be used.

The Bluetooth display (FIG. 15) activates connectivity functions. In Bluetooth, the system will automatically wirelessly connect to one (or more) of a plurality of devices (e.g., 504 in FIG. 5) to be controlled by the head array input 110 and/or other inputs 506 and 508. Upon successful connection, head array 110 will be activated for input control of the connected device(s). As previously described, this can include a wide variety of Bluetooth-enable devices.

FIG. 16 illustrates the Next Function display. In this mode, the logic will move through the functions programmed within a profile. A profile can be, for example, defined by one or more functions. For example, a profile can include a drive, seating, and/or connectivity functions. A drive function defines how a wheelchair drives when a drive signal is input (e.g., the forward speed, acceleration, deceleration, turning speed, etc.) A seating function allows control of power seating systems like tilt and recline, for example. A connectivity function allows for wireless connectivity to smartphones, tablets, computers, etc.

Programmer and display 118 can send control signals to main controller 510 for displaying and navigating through the functions associated a particular profile. This can be accomplished via a momentary switch activation (e.g., 506 and/or 508) or other user input as a control signal to advance to the next function. Once a function navigated to on main controller 510, that function is active and controllable through input devices such as, for example, head array 110, switches, joysticks, etc. In another embodiment, the functions can be displayed, navigated, controlled and adjusted on programmer 118 in the same manner as through main controller 510. In this way, a user is able to use head array 118 and/or an associated input device (e.g., 506 and/or 508) to navigate the functions of the main controller 510.

FIG. 17 illustrates the Next Profile display. In this mode, the logic will move through (e.g., scroll) and display and select the profiles programmed in main controller 510. Profiles can be defined for indoor driving, outdoor driving, etc. and include the previously described functions (e.g., drive, seating, connectivity, etc.) Main controller 510 typically includes more than one profile. Programmer and display 118 sends control signals to main controller 510 for displaying and navigating through the profiles associated with the power wheelchair. This can be accomplished via a momentary switch activation (e.g., 506 and/or 508) or other user input. In another embodiment, the profiles can be displayed and adjusted on programmer 118. Once a profile is navigated to, it is active and controllable through its functions (e.g. drive, seating, connectivity, etc.)

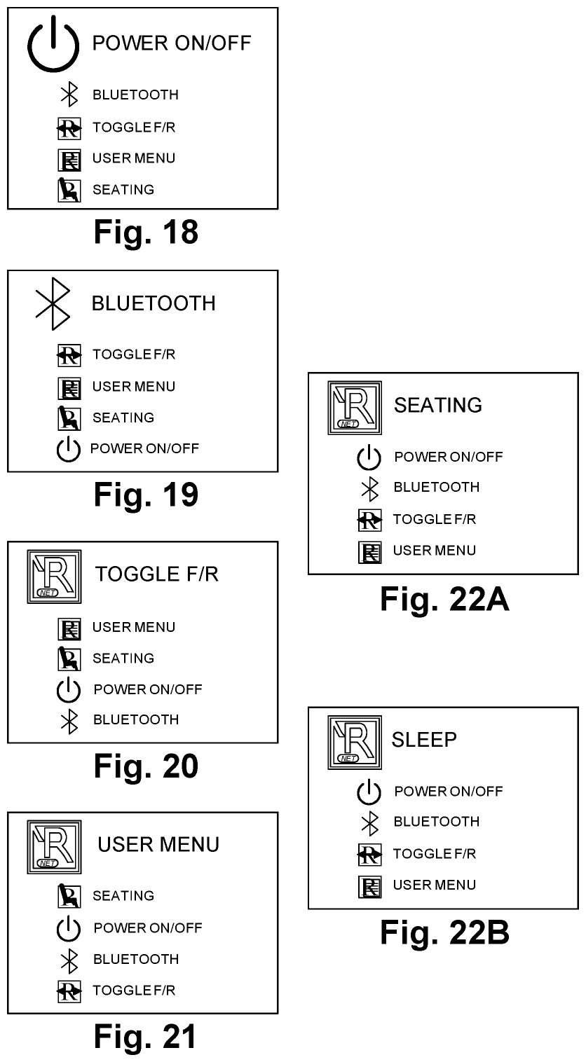

FIGS. 18-22B illustrate an alternative main logic loop and displays for a different main controller 510. In this example, the main logic loop is based on the R-Net wheelchair controller system 510. FIG. 18 shows navigable items as Bluetooth, Toggle F/R (forward/reverse), User Menu, and Seating. Again, these are exemplary and other system functions can also be displayed and selected. If the switch (e.g., 506 or 508) is pressed and held for a short duration, the next line item (e.g., Bluetooth as shown in FIG. 19) will be highlighted. The next press and hold will advance the display to next item (e.g., Toggle F/R as shown in FIG. 20) will be highlighted. The next press and hold will advance the display to next item (e.g., User Menu as shown in FIG. 21). The next press and hold will advance the display to next item (e.g., Seating as shown in FIG. 22A). FIG. 22B shows the display and logic of when the main controller 510 has entered a sleep mode (e.g., typically entered when an input command is not received before the expiration of a predefined sleep time limit.) In these displays, the logic monitors if the switch is momentarily pressed and released, then the highlighted line item is selected, and a control selection signal based thereon is sent to main controller 510 to indicate this is the selected function for control by user input device(s). Thus, the main logic loop continues in this manner allowing selection of items (e.g., Bluetooth, Next Function, Next Profile, etc.) for control. This loop continues until a programming mode is activated.

In block 808, the logic activates a Programming mode. The programming mode allows diagnostics and modification of head array pad settings, user settings, and feature settings. In one embodiment, the programming mode can be activated by depressing and holding buttons 516 and 518 of the programming unit 118. Other input combinations are also possible to activate the programming mode.

In block 810, the logic displays diagnostics such as for example pad settings and pad responsiveness to input (e.g., block 812 Pad Drive Demand.) Pad settings include indications of whether each pad is set to digital or proportional mode. Pad responsiveness is indicated by displaying the pad sensor output in response to either proximity and/or force being applied to the pad. Other diagnostics can also be displayed.

In block 814, the logic allows for programming of various Settings including, for example, Pad, User, and Feature. Blocks 816 and 822-828 illustrate logic programming or modifying pad settings. In block 816, the logic allows for modifying Pad settings relating to Type, Direction, and Veer Adjust. Block 822 displays the logic for modifying the Pad Type setting. This allows the Pad Type to be set as either a Proportional or Digital type pad. As previously described, a Proportional type of pad sensors the amount of pressure or force applied to the pad and generates a proportional control signal based thereon. A Digital type of pad senses the proximity (e.g., a user's head) and generates a digital (i.e., on or off) control signal based thereon. If the Pad Type is set to Proportional, the logic in block 828 allows the proportional pad to be calibrated. This includes setting the pad's minimum and maximum responsiveness (e.g., minimum force/pressure necessary to generate a control signal and maximum force/pressure allowable to generate a corresponding control signal).

In block 824, the logic allows for the setting of Pad Direction. This includes, for example, the directions of left, right, forward, reverse, and off. The off setting means the pad is off and does not respond to any input by the user. Each pad's direction can be customized to any of these directions or settings.

In block 826, the logic allows for a Veer Adjust setting. As previously described, due to manufacturing variances, many power wheelchairs do not drive in a straight line when given a forward command, but instead exhibit veer (e.g., tending to drive more to the left or right instead of straight ahead). The Veer Adjust setting allows a veer correction signal that is added to the direction (and/or speed) signal generated from the head array 110. This adjusted input signal is then used by main controller 510 to drive the left and right motors of the wheelchair, which should correct for veer, so the wheelchair drives straight ahead.

In block 818, the logic allows for modification of User Settings. Example User Settings include Audio feedback on or off, Power up Idle (e.g., one or more user input devices like head array 110 is inactive upon power up), selection of main controller type (e.g., R-Net controller type enable or disable), and Timeout setting defining the length of time a user switch (e.g., 506 and/or 508) must be depressed and held in order to advance to the next item, setting or display. Other User Settings can also be included for modification.

In block 820, the logic provides for modification of Feature Settings. Feature settings include, for example, enabling or disabling features of the main controller 510 such as Bluetooth functionality, Next Function selection, Next Profile selection, Power on/off, etc. These features were previously described as part of the logic's main control loop in block 806. Other Feature Settings can be included for modification as well.

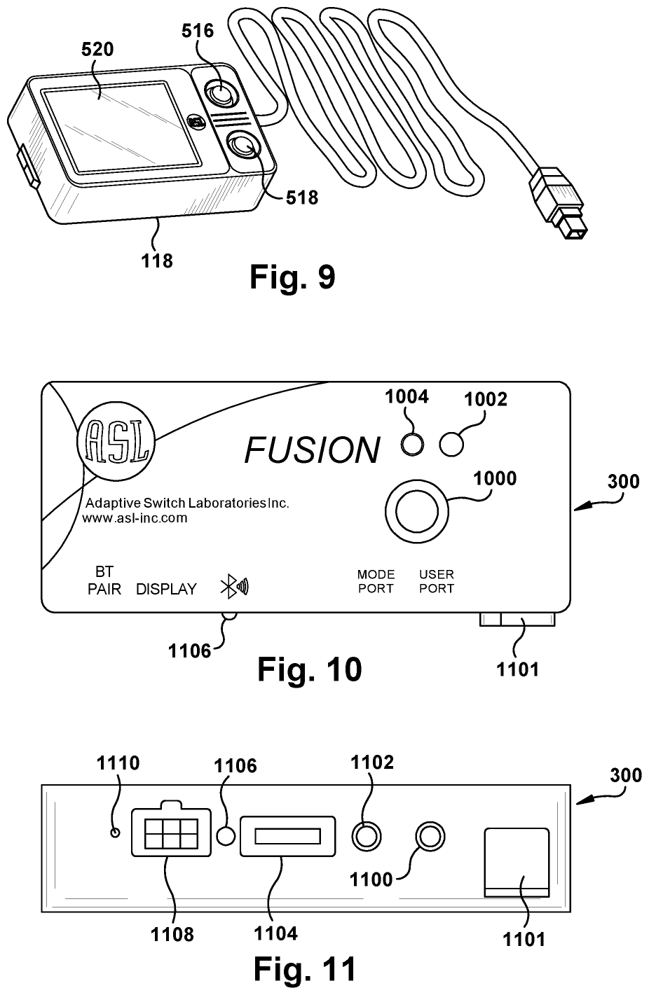

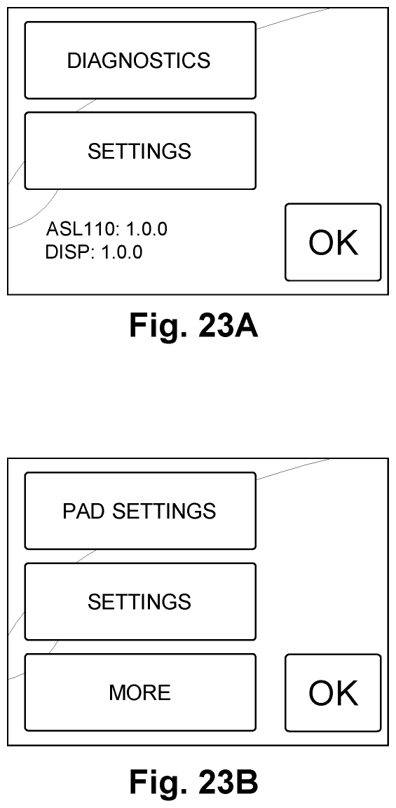

The programming functions 808-828 are displayed, selected, adjusted, and controlled via the functions and displays further discussed herein in association with FIGS. 23A-43. Referring now to FIG. 9, the programming and parameter adjustments can be made by touching the touch screen display 520 and/or buttons 516 and 518 of the programmer 118. Programmer 118 connects and communicates with control interface 300, which connects and communicates with main controller 510 to control the power wheelchair.

FIGS. 10 and 11 illustrate one embodiment of control interface 300. Control interface 300 has a housing that includes a membrane covered On/Off switch, power light 1002 (e.g., green for driving mode, amber for Bluetooth mode, and off for no power), and light sensor 1004 for automatically dimming power light 1002 based on ambient light levels. The housing also includes ports 1100 and 1102 for user and mode inputs via, for example, one or more switches, control and power connection port 1101 (e.g., for communication with main controller 510), head array 110 connection port 1106, Bluetooth indicator light 1106 (e.g., flashing indicates no pairing, solid indicates paired, no light indicates Bluetooth is turned off), programmer and display 118 connection port 1108, and Bluetooth pairing port 1110 (e.g., for an external Bluetooth communication device). So arranged, head unit 110 and programmer and display 118 connect to interface controller 300, which connects to main controller 510 for directing operation of the power wheelchair.

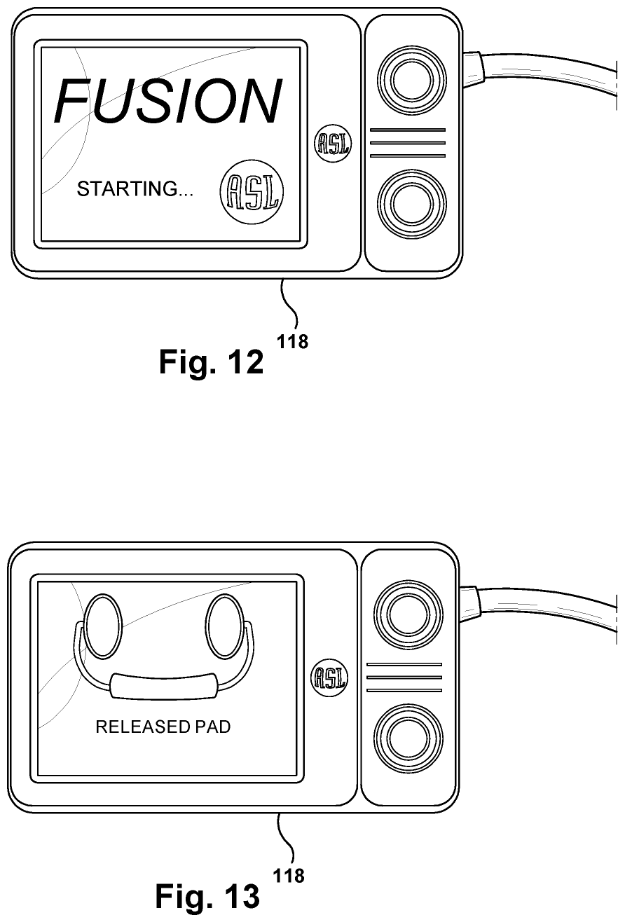

Referring now to FIG. 12, one example of a startup display is shown. FIG. 13 illustrates in Out of Neutral display that is generated during start up if one or more of the head array 110 pads are activated. The Out of Neutral display includes a graphical representation of head array 110 including its associated pads. The activated pad(s) (e.g., the out of neutral pads) are displayed in a different color to indicate to the user which pads are activated. A message is also displayed instructing “Release Pad” to de-activate the pad. In other embodiments, the graphical representation of the head array 110 can be replaced with a text and/or iconic listing/display of the head array pad(s) and their status (e.g., active or not active).

FIGS. 14-17 illustrate the main control loop displays of the logic that is already been discussed in connection with FIG. 8. Similarly, FIGS. 18-22 illustrates another embodiment of the main control loop displays of the logic already discussed in connection with FIG. 8. Those discussions are hereby incorporated by reference herein.

FIGS. 23A-B illustrate embodiments of an initial programming display. In the embodiment of FIG. 23A, the display provides for selection of Diagnostics or Settings. In the embodiment of FIG. 23B, the display provides for selection of Pad Settings, Settings, More. As previously described, programming mode can be activated by depressing and holding both buttons 516 and 518 and programmer 118. This action causes the logic to exit the main control loop and enter a programming loop. The Diagnostics, Settings, and Pad Settings programming functions have been described above in connection with FIG. 8 in the present discussion will further describe these functions and their displays.

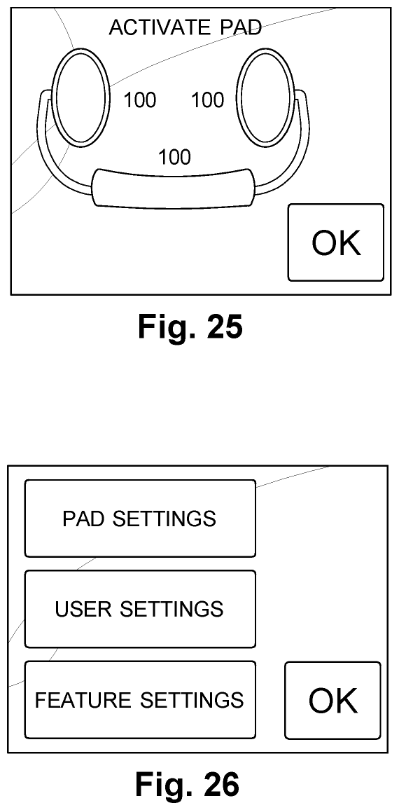

FIG. 25 illustrates one embodiment of a diagnostic screen generated by the logic when the user selects Diagnostics from FIG. 23A. The display includes a graphical representation of head array 110 and the activation status of each pad. The activation status is indicated numerically for each pad as a percentage of the pad's control signal (e.g., “100” for a fully activated pad). For Digital pad, which would be colored in green, the activation status indication is typically 0 (e.g., Off) or 100 (e.g., On). For Proportional pad, which would be colored in orange, activation status indication is typically a range from 0 to 100. These values are representative and other values can be used instead. Also, other colors or indications can also be used to differentiate between Digital and Proportional type pads. Thus, through this diagnostic display, a user can actively monitor how a pad responds with its control signal as it senses proximity or force/pressure being applied to it.

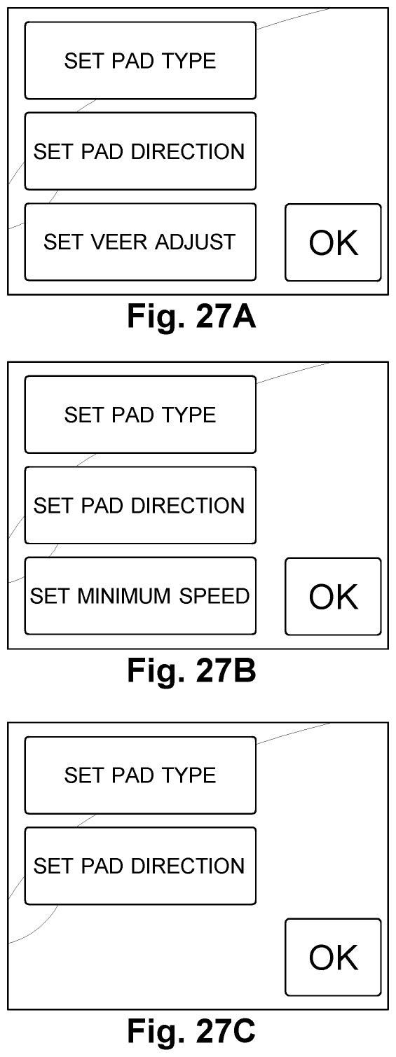

FIGS. 26 illustrates one embodiment of a Settings programming display and logic. The programming display and logic of FIG. 26 is generated when Settings is selected from FIG. 23A. Through this display, the logic allows for various settings to be selected including Pad Settings, User Settings, and Feature Settings. The display and logic of FIGS. 27A, 27B or 27C are generated in response to a selection of Pad Settings from 23B. The displays of FIGS. 27A-27C allow selection of Set Pad Type, Set Pad Direction, Set Veer Adjust (in the case of FIG. 27A), and Set Minimum Speed (in the case of FIG. 27B).

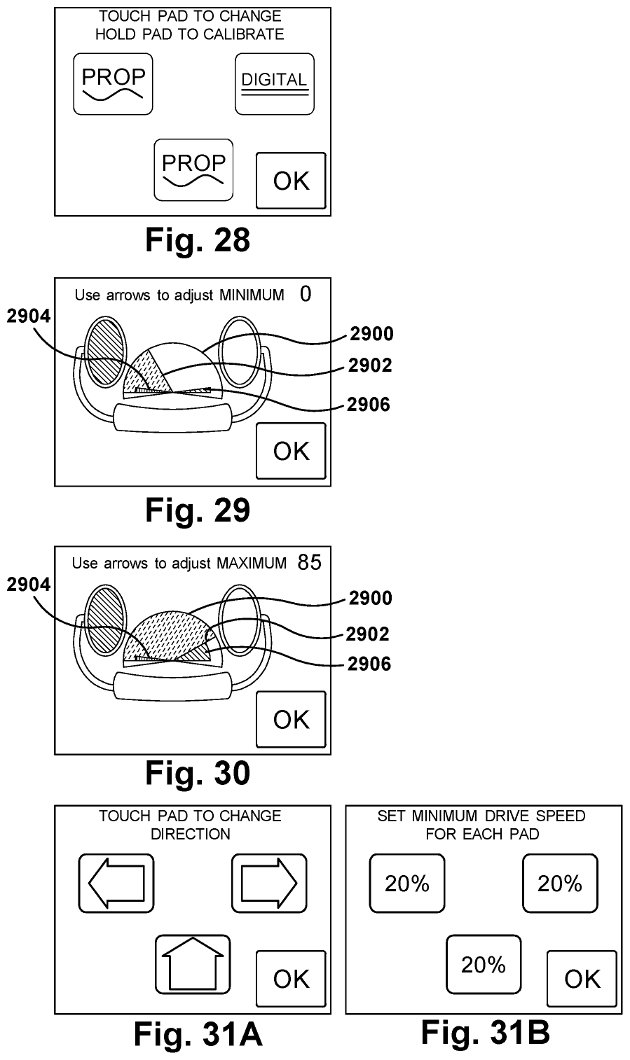

FIG. 28 illustrates one embodiment of a Set Pad Type display and logic. The display and logic generate a graphical representation of the head array 110 pads. The display includes an indication of the pad type setting for each pad (e.g., Digital or Proportional (“PROP”)). A further indication is provided graphically with a wave-type graphic representing Proportional and a dashed line-type graphic representing Digital. Also, different display colors can be used for Digital and Proportional pad type setting indications to further facilitate differentiation. Other graphical/display representations may also be used.

In FIG. 28, the left and center pads are set to Proportional and the right pad is set to Digital. The pad type is changed by touching the graphical representation of the pad on the display. Each touch will change the pad type from Proportional to Digital and vice-versa. In this manner, the Pad Type setting is programmed for each pad of head array 110. In other embodiments, the button 516 can be used to cycle through selection of each pad and button 518 can be used to cycle through selection of pad type. Other types of inputs can also be used to set the pad type.

FIGS. 29 and 30 illustrate one embodiment of the display and logic for calibrating a pad. In one embodiment, the minimum and maximum force required to activate proportionality for each Proportional pad type can be programmed. The display of FIG. 29 is generated by pressing and holding down on any of the pad graphical representations shown in FIG. 28. This action launches the calibration screen of FIG. 29 (and subsequently FIG. 30) for the selected pad of the head array 110. The display and logic of FIG. 29 includes a graphical representation of the head array 110 and its pads. The selected pad is graphically highlighted (e.g., via color or some other graphical indication) for calibration. The display and logic of FIG. 29 also includes a graphical calibration meter 2900. In one embodiment, calibration meter 2900 mimics an analogue meter with a deflection needle 2902 to represent the level or reading. In other embodiments, calibration meter 2900 can be a bar-type meter, numeric meter, or other type of meter display.

Calibration meter 2900 can also include an indication of Minimum 2904 and Maximum 2906 settings for the force required before a Proportional control output signal is generated for use in driving the power wheelchair. In the embodiment of calibration meter 2900 shown, the Minimum 2904 and Maximum 2906 settings are graphically represented by pie chart segments that are differentiated in color and inset on the calibration meter 2900. A numerical indication of the Minimum setting 2904 is also provided in the display of FIG. 29.

The display and logic of FIG. 29 allows for adjustment or programming of the Minimum settings 2904. In one embodiment, the minimum setting 2904 represents the force required to initiate or start proportional control. The adjustment is made by pressing buttons 516 and 518 on programmer 118. For example, button 516 can be used to increase and button 518 can be used to decrease the value of the Minimum setting 2904. As the value of the Minimum setting 2904 is increased or decreased, the size of the corresponding graphical pie chart segment is increased or decreased to reflect the adjusted value.

After the Minimum settings 2904 is set, the logic and display of FIG. 30 is generated allowing for adjustment or programming of the Maximum setting 2906. In one embodiment, the Maximum setting 2906 represents the force required for reaching 100% of the programmed speed. The adjustment is accomplished in the same manner as described for the Minimum setting 2904 using programmer 110 buttons 516 and 518 to increase or decrease the value. As the value of the Maximum setting 2904 is increased or decreased, the size of the corresponding graphical pie chart segment is increased or decreased to reflect the adjusted value.

In FIGS. 29 and 30, calibration meter 2900 can be a real time display of the force being applied against the selected head array 110 pad. By having a real time display of the force being applied, the adjustment or programming of the Minimum 2904 and Maximum 2906 force settings required for proportional control signal output can be made in the context of actual force measurements. The calibration logic and displays of FIGS. 29 and 30 are applicable to each pad selected for calibration.

FIG. 31A represents the logic and display for setting pad direction. FIG. 31A is generated when Set Pad Direction is selected from either FIG. 27A or 27B. The display and logic of FIG. 31A includes a graphical representation of each pad of head array 110. Each graphical representation includes an indication of the direction controlled by the pad. For example, in the embodiment shown in FIG. 31, the left pad generates a left direction signal, the right pad generates a right direction signal, and the center or back pad generates a forward direction signal. The pad direction for each pad is changed by pressing the graphical representation of the pad on the display. In one embodiment, each press cycles through the pad directions of left, right, forward, and off. Additional pad directions can be included such as reverse. Graphical representations of each pad direction are correspondingly displayed including arrows representing the directions of left, right, and forward. The Off setting is represented by a graphical indication using the words “Off.” Other graphical representations including the use of color can also be used.

FIG. 31B shows the logic and display for setting minimum drive speed for each pad. FIG. 31A is generated when Set Minimum Speed from FIG. 27B is selected. The display and logic of FIG. 31B includes a graphical representation of each pad of head array 110. In the embodiment shown, within each pad's graphical representation, an indication of the minimum drive speed set for each pad is displayed. The indication can be a numeric of other indication (e.g., Low, Med, Hi, etc.) The minimum drive speed for each pad can represent, for example, a percentage of the overall set maximum or otherwise permitted top speed (or range) set in programmer 118 and/or main controller 510. A pad is selected for adjustment by touching its graphical representation on touch display 520. Input buttons 516 and 518 on programmer 118 can be used to then raise or lower the set minimum drive speed associated with the pad. In the example display shown, in FIG. 31B, the left, right and center/back pads are each set to provide a minimum drive speed of 20%. For example, center/back pad activation provides a minimum forward (or reverse) drive speed of 20%. Activation of the left pad provides a minimum left turn speed of 20%. Similarly, activation of the right pad provides a minimum right turn speed of 20%. While each pad in FIG. 31B is shown with a 20% value, each pad may have a different value than the other pads. The Minimum Speed value can be used for both Digital and/or Proportional type pads. These values are typically set by, for example, a therapist with knowledge of the user's needs and capabilities to drive a power wheelchair having a head array.

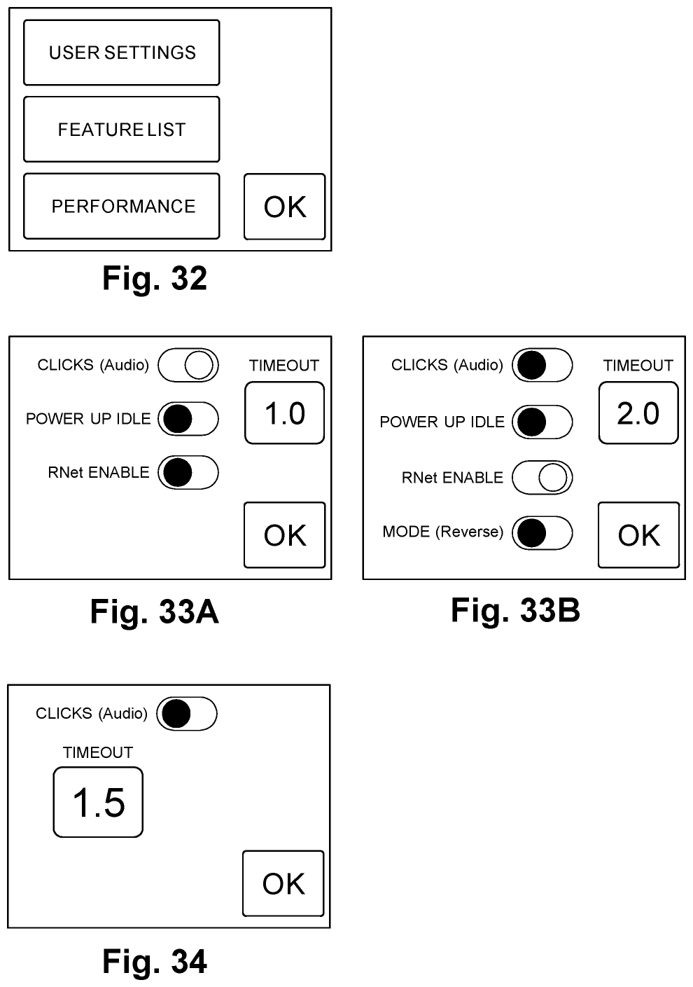

If User Settings is selected from FIG. 23A, 23B, or 26, the display and logic of FIG. 32 is generated. The display of FIG. 32 includes various adjustable or programmable settings including User Settings, Feature List, and Performance. If User Settings is selected by touching it on the touch display, the display and logic of FIGS. 33A or 33B is generated. The displays of FIGS. 33A and 33B include various User Settings and indications such as, for example, CLICKS (Audio) on/off, POWER UP IDLE on/off, RNet Enable on/off, and (Mode (Reverse) (in the case of FIG. 33B). In the embodiment of FIGS. 33A and 33B, the on/off (or enable/disable) selection is made via graphical on/off slider buttons that are selected by touching the touch display. Other forms and graphical inputs can be used as well for this function. The CLICKS (Audio) user setting enables or disables an audio click generated after each user input to the programmer (whether by touch display, switch or button). The POWER UP IDLE user setting enables or disables (e.g., IDLE) use of the head array 110 upon power up. A press of a user switch (e.g., 506 or 508) will enable use of the head array 110. The RNet Enable user setting enables or disables programmer 110 configurations for RNet-type main controllers. The Mode (Reverse) user setting (in the case of FIG. 33B) enables or disables the reverse direction of driving for purposes of driving input commands. Enabling the Reverse mode means the drive control signals from head array 110 will be interpreted to represent driving the wheelchair in the reverse direction (e.g., rearward). A TIMEOUT user setting adjusts the time required for switch depression and hold in order to advance to a next item on the display of programmer 110 when an external switch (e.g., 506 and/or 508) are being used. The TIMEOUT value can be adjusted via pressing the TIMEOUT indication on the display or pressing buttons 516 and 518 on the programmer 118. The TIMEOUT values are at fixed amounts such as, for example, 1, 1.5, 2, 2.5, 3, 4, 5 (sec) and off. Other values can also be used. In another embodiment, more of less of these user settings can be displayed such as, for example, in the display of FIG. 34 where only the CLICKS (Audio) and TIMEOUT user settings are shown. Still further additional user settings can be displayed for enabling/disabling, which includes Seating and Sleep mode activation. The Seating setting enables/disables use of the head array 110 to control a power seating system that may include power recline, tilt, and/or raise and lower. The Sleep setting can be used to enable/disable a sleep mode that puts main controller 510 to sleep should no input signals be generated thereto during a predefined time limit (e.g., one or more minutes).

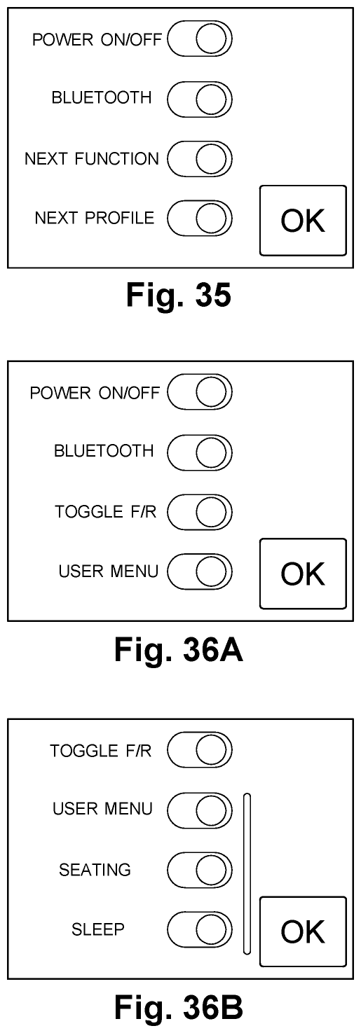

If Feature Settings is selected in FIG. 26, the display and logic of FIG. 35, 36A, or 36B is generated depending what type of main controller 510 is connected (and enabled in User Settings). FIGS. 35, 36A, and 36B show features that can be enabled and disabled via graphical slider button indications. The features listed are dependent on the type of main controller 510 that is connected. For example, the display and logic of FIG. 35 can apply to a first type of main controller 510 and the display and logic of FIGS. 36A and 36B can apply to a second type of main controller 510. In one embodiment, the display and logic of FIGS. 36A and 36B can be combined through the use of a graphical scroll bar so that all features are listed on one screen that can be scrolled up and down. The graphical scroll bars can be horizontal and/or vertical and can be positioned anywhere on the display. Furthermore, swipe motion can also be used on touch display 520 to scroll the shown displays. The use of a graphical scroll bar and/or swipe motion may also be applied to any of the displays disclosed herein to make the displays larger than the physical touch display 520.

If Performance in FIG. 32 is selected, the display and logic of FIG. 37 is displayed where graphical indications of Set Veer Adjust and Set Minimum Speed can be selected for adjustment or programming. If Set Veer Adjust is selected, the display and logic of FIG. 38 is generated. The display and logic of FIG. 38 can also be generated by selecting Set Veer Adjust from FIG. 27A. The Veer Adjust setting allows a veer correction signal to be generated that is added to the direction (and/or speed) signal generated from the head array 110. This adjusted input signal is then used by main controller 510 to drive the left and right motors of the wheelchair, which should correct for veer, so the wheelchair drives straight ahead.

The logic and display of FIG. 38 includes a graphical veer adjustment selector 3800 having a slider bar and slide knob 3802. A numerical indication 3804 of the veer adjustment setting is displayed. The veer adjustment is made by touching the touch display and sliding knob 802 (left or right) along the slider. The logic reads the movement of the slide selector knob 3802 and assigned a value to its position. In one embodiment, the center of the slide selector input bar indicates a zero (0) or no adjustment position. Movement of the slide knob 3802 to the left of the center position creates a negative veer adjust whose value increases the further way from center the slide knob 3802 is moved. Similarly, movement of the slide knob 3802 to the right of the center position creates a positive veer adjust whose value increases the further away from the center the slide knob 3802 is moved. The veer adjust value (negative or positive) is added to the direction signal generated by the head array 110 to correct for any veering caused by the wheelchair during travel. As slider knob 3802 is moved, numerical display 3804 is updated to indicate the presently set veer adjust input value. In one embodiment, the veer adjust value is limited to a range of −12 to +12, though any range can be used. In other embodiments, the slide knob 3802 may be moved left or right via buttons 516 and 518 on programmer 118.

The veer adjust value is combined with the drive direction signal from the head array 110 to create a corrected drive direction signal. The corrected drive direction signal is then provided to main controller 510 to drive the power wheelchair motors in accordance thereof. In alternative embodiments, the veer adjust value can be sent from programmer 510 to main controller 510 for main controller 510 to combine it with the drive direction signal. In this manner, programmer 118 allows for a veer adjust value generated and used to correct wheelchair travel for the user of the head array.

If the Set Minimum Speed is selected in FIG. 37, the logic and display of FIG. 39 is generated. The Set Minimum Speed allows for both Digital and Proportional speed control. The Minimum Speed value allows movement of the wheelchair in Digital mode (i.e., when proximity close to the pad is detected) to begin and increase to the set Minimum Speed value. Once this Minimum Speed value is achieved, further movement of the wheelchair is controlled by the Proportional mode (i.e., when force is applied to the pad). This defines the Proportional Minimum Drive Speed value. In one embodiment, the value can be adjusted or programmed to be 15%, 20%, 25%, or 30% of the maximum allowable speed. Other values and ranges can also be used. An OFF value can also be selected to turn off this feature (i.e., turn off the Digital control component) so that movement of the wheelchair only occurs under Proportional control (i.e., when force is applied to the pad). The values can be selected by touching the numeric indication on the display or using buttons 516 and 518 to cycle through the selections. See also the description of FIG. 7 explaining Digital (i.e., or proximity) and Proportional (i.e., force) control. In other embodiments, FIG. 37 can include only the Set Veer Adjust setting and the Set Minimum Speed setting can have its own display and logic as shown FIG. 39 and/or FIG. 31B.

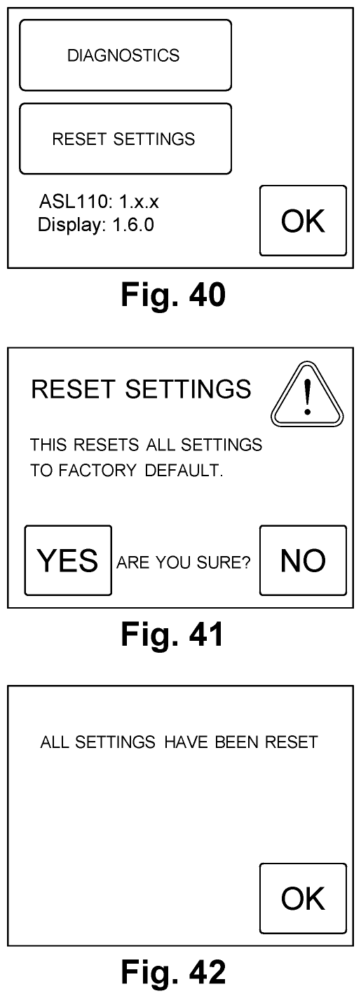

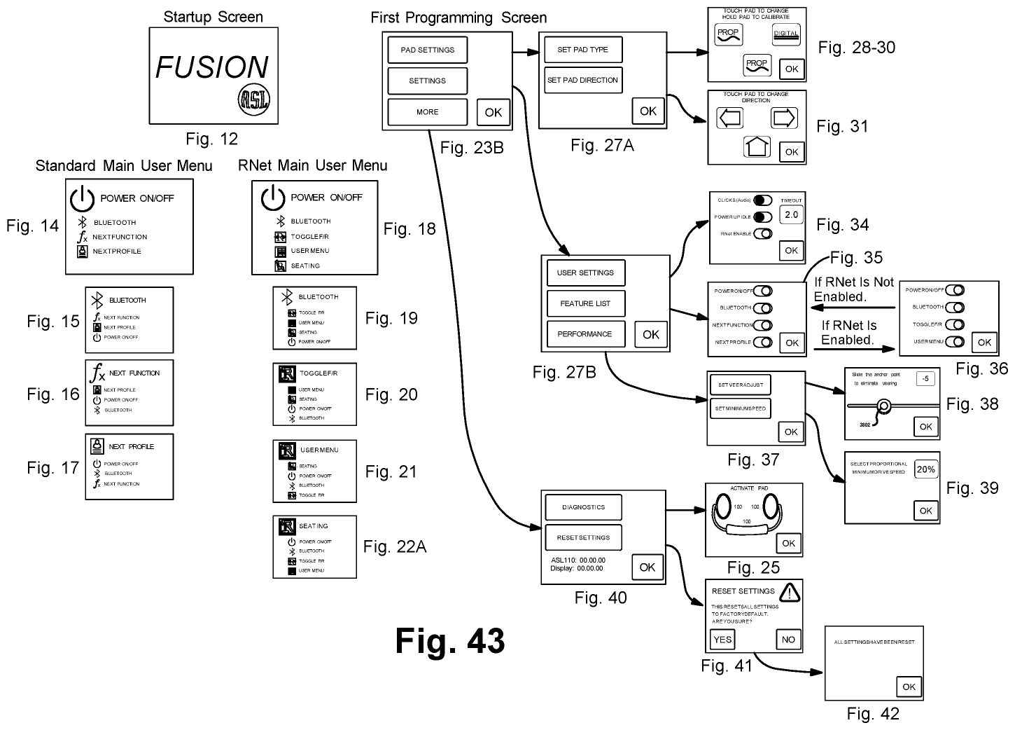

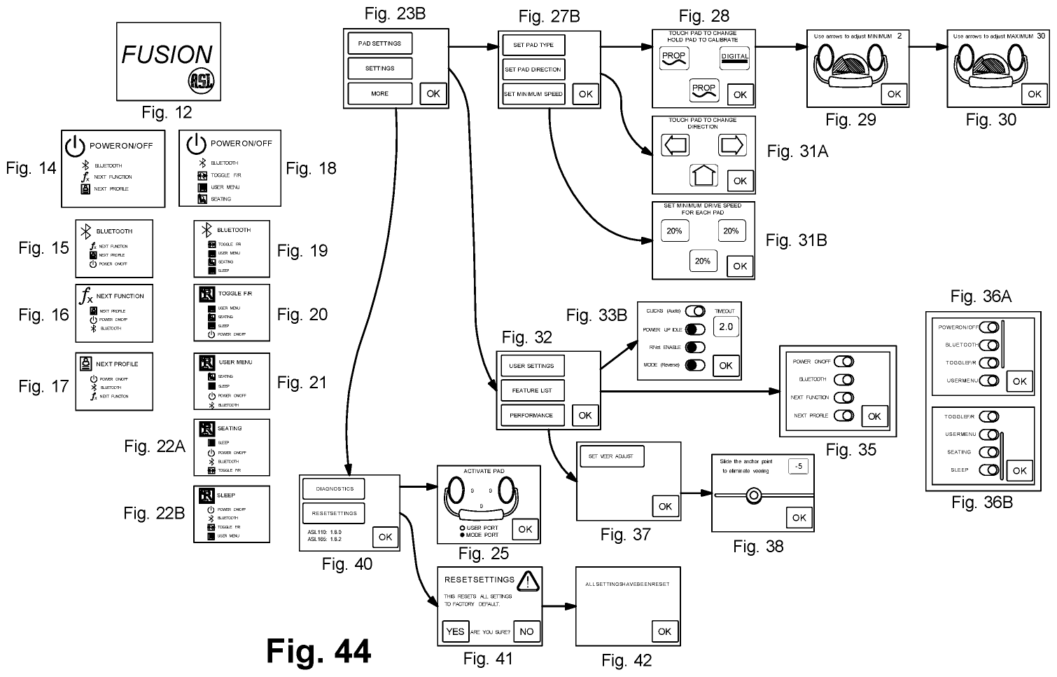

The display and logic of FIG. 40 is generated by selected More from FIG. 23B. The display and logic of FIG. 40 include selectable times indicated as Diagnostics and Reset Settings. If Diagnostics is selected, the display and logic of FIG. 25 is generated. FIG. 25 has been discussed previously and reference to that discussion is incorporated herein. If in the display of FIG. 40 the Reset Settings item is selected, then the logic and display of FIG. 41 is generated. FIG. 41 includes a graphical warning indication that proceeding further with a Yes selection will reset all settings to factory default. Selection of the No indication will return the display to that of FIG. 40 and will not reset all settings. If the Yes indication was selected in FIG. 41, the display and logic of FIG. 42 will be generated indicating that all settings have been reset to their factory default values.

FIGS. 43 and 44 show embodiments of a high-level map or flow diagram of the logic and displays discussed herein. As previously mentioned, the touch screen displays, functions, and programming sequences shown and described can be modified to include more or less than that shown. Additionally, the logic and flow does not have to occur in the order or sequence presented but can be changed to different orders and flow sequences to accomplish the disclosed logic and functions.

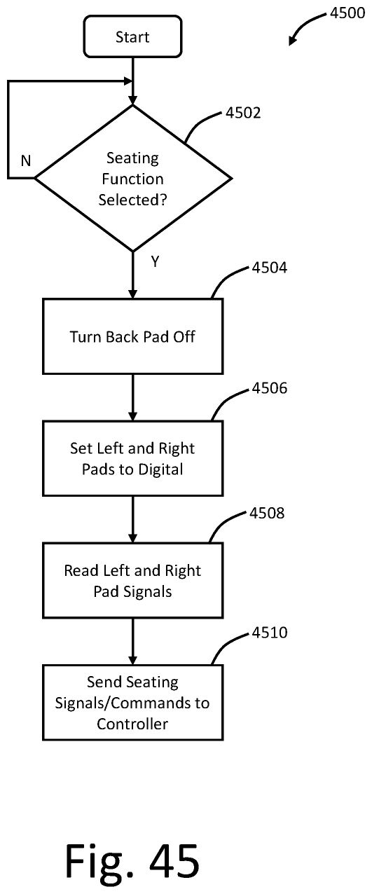

Referring now to FIG. 45, a logic diagram 4500 is shown for when the Seating function is selected (e.g., from FIG. 22A). In block 4502, the logic determines of the Seating function has been selected or activated. If so, the logic advances to block 4504 where the back or center pad of head array 110 is turned off or disabled. In block 4506, the logic also sets the Pad Type setting for the left and right pads to Digital (e.g., to provide only on and off signals). In block 4508, the logic reads any left and right pad input signals for seating control. Block 4510 communicates any left and right pad input signals to the controller for seating functionality. In one embodiment, the left and right pad input signals are interpreted as seating commands and sent to either main controller 510 or to a dedicated seating controller. The controllable seating functions include, for example, tilt, recline, elevate, etc. The left and right pad input signals can be used to control these functions such as increase/decrease tilt, increase/decrease recline, elevate/lower, select, etc. In this scenario, the back or center pad is turned off or disabled in order avoid generating any error codes when main controller 510 (or the seating controller) is expecting only left and right (e.g., direction-type) input signals for seating function control.

Embodiments inventions disclosed throughout this disclosure have been described as having various forms of logic to accomplish their functions and displays. This logic is, for example, can be stored in the memory of programming unit 118 or main controller 510 and executed by processing circuits therein. The logic can be in the form of computer-readable and executable instructions that reside in software or firmware. The logic can also be implemented in digital logic circuits. Moreover, though the logic has been described in terms of sequence(s) of steps or processes, the order of those sequences can be changed while still obtaining the disclosed results. Hence, the logic descriptions herein are illustrative and can be implemented in any suitable manner and on any suitable software or logic platform.

While the present inventions have been illustrated by the description of embodiments thereof, and while the embodiments have been described in considerable detail, it is not the intention of the descriptions to restrict or in any way limit the scope of the inventions to such detail. Additional advantages and modifications will readily appear to those skilled in the art. Therefore, the inventions, in their broader aspects, are not limited to the specific details, the representative apparatus, and illustrative examples shown and described. Accordingly, departures can be made from such details without departing from the spirit or scope of the general inventive concepts.

1. A mobility vehicle comprising:
a first controller for controlling the speed and direction of the vehicle,
a head array connected to a second controller,
the second controller in communication with the first controller and wherein the second controller comprises:
a display and at least one input device; and
logic for correcting the veer of the vehicle.

2. The vehicle of claim 1 wherein the logic for correcting the veer of the vehicle comprises logic for generating a veer adjustment display.

3. The vehicle of claim 1 wherein the logic for correcting the veer of the vehicle comprises logic for reading a veer adjustment input.

4. The vehicle of claim 1 wherein the logic for correcting the veer of the vehicle comprises logic for modifying a drive direction signal by a veer adjustment signal.

5. The vehicle of claim 2 wherein the logic for generating a veer adjustment display includes logic for generating a graphical veer adjustment selector.

6. The vehicle of claim 3 wherein the logic for generating a graphical veer adjustment selector includes logic for generating a graphical slider bar and slider knob.

7. The vehicle of claim 6 wherein the logic for logic for correcting the veer of the vehicle comprises logic for reading the position of the graphical slider knob on the slider bar to generate a veer adjustment value.

8. The vehicle of claim 7 wherein the logic for correcting the veer of the vehicle comprises logic for combining the drive direction signal from the head array with the veer adjustment value.

9. The vehicle of claim 1 wherein the logic for correcting the veer of the vehicle comprises logic for combining a drive direction signal from the head array with a veer adjustment value input by the user to generate a corrected drive signal.

10. The vehicle of claim 9 wherein the logic for correcting the veer of the vehicle comprises logic for sending the corrected drive signal to the first controller for driving the power wheelchair.

11. A mobility vehicle comprising:
a head array control system having:
a head array with at least one sensor pad;
a control interface for interpreting signals from the head array and providing vehicle speed and direction signals; and
a head array programmer and display for adjusting the settings of the head array, wherein the head array programmer comprises a veer adjustment interface for allowing a veer adjust parameter to be defined for correcting the veer of the vehicle.

12. The mobility vehicle of claim 11 wherein the veer adjustment interface comprises a graphical input display.

13. The mobility vehicle of claim 11 wherein the veer adjust interface comprises a graphical slider bar having a slide knob that is movable by a user input.

14. The mobility vehicle of claim 11 wherein the veer adjust interface comprises logic for combining the veer adjust parameter with a drive direction control signal from the head array.

15. The mobility vehicle of claim 11 wherein the veer adjust interface comprises logic for limiting the veer adjust parameter to a positive and negative range of values.

16. A mobility vehicle comprising:
a head array control means having:
a head array means;
a control interface means for interpreting signals from the head array means and providing vehicle speed and direction signals; and
a head array programmer and display means for adjusting the settings of the head array control means, wherein the head array programmer means comprises a veer adjustment interface means for allowing a veer adjust parameter to be defined for correcting the veer of the vehicle.

17. The mobility vehicle of claim 16 wherein the veer adjustment interface means comprises a graphical means for input.

18. The mobility vehicle of claim 16 wherein the veer adjust interface means comprises a means for generating and sensing the movement of a graphical slider bar having a slide knob.

19. The mobility vehicle of claim 16 wherein the veer adjust interface means comprises means for combining the veer adjust parameter with a drive direction control signal from the head array means.

20. The mobility vehicle of claim 16 wherein the head array programmer and display means comprise a means for adjusting the sensor pad type of the head array means.
